(19) United States
(12) Patent Application Publication
(10) Pub. No.: US 2009/0239196 A1
(43) Pub. Date: Sep. 24, 2009

(54) Dental implant system

(76) Inventors: Sheldon A. Lerner, Brooklyn, NY (US); Albert Zickmann, Chicago, IL (US)

Correspondence Address: BERNARD MALINA, ESQ.,;MALINA & ASSOCIATES, PLLC, Suite 501, 60 East 42nd Street, New York, NY, 10165, US

(21) Appl. No.: 12/077,286

(22) Filed: Mar. 18, 2008

(51) Int. Cl. A61C 8/00

(52) U.S. Cl. 433/174

(57) ABSTRACT

A system for dental implants which includes a dental implant having a central bore, a threaded portion, an abutment having a central bore and a tapered portion, and a fastening screw. The fastening screw has a threaded portion, which engages the dental implant and a tapered head which forms a locking engagement with the tapered portion of the abutment.

### FIELD OF THE INVENTION

The present invention relates generally to the field of dental prosthetics and more particularly, to a dental implant system.

### BACKGROUND OF THE INVENTION

The prior art related to dental implant systems includes the following U.S. patents.

U.S. Pat. No. 7,090,495 B1, for a “Dental Implant Screw and Post System” to Rosen shows an assembly which includes a first part which may be attached to a prosthetic tooth and an implant. The implant is configured for receiving a threaded fastener. The threaded fastener includes a head portion and a threaded portion. The head portion has a taper configuration. The head portion descends into the implant for the purpose of shielding the threaded portion of the screw from masticating forces during use.

U.S. Pat. No. 7,264,469 B2 to Albarno for a “Split-Implant and Abutment System for Dental Reconstruction” includes an apical insert which is secured to the jawbone and another component such as a coronal base. The apical insert and the coronal base are mutually secured via a tapered Morse fit. The device uses a straight fastener which passes through an abutment and which also passes through the coronal base to secure the abutment and the coronal base to the apical insert.

U.S. Pat. No. 7,137,817 B2 to Mena shows an Implant Fixation Device which includes a portion which is implantable into tissue and which has an external thread. The device also has a straight internal thread.

### OBJECTS AND SUMMARY OF THE INVENTION

It is an object of the present invention to provide a dental implant system which includes an abutment, a dental implant and a fastening screw, and in which the abutment and the fastening screw each have a complementary Morse taper.

Another object of the present invention is to provide a dental implant system in which the fastening screw and the abutment are in locking engagement.

Another object of the present invention is to provide a dental implant system which may be easily and conveniently attached to a patient's jawbone thereby minimizing patient discomfort.

Yet another object of the present invention is to provide a dental implant system which may be manufactured efficiently in volume.

Despite the developments of the prior art, there remains a need for a dental implant system in which the fastening screw and the abutment each have a Morse or locking taper.

In accordance with the present invention, there is provided a dental implant system which includes an abutment, a dental implant and a fastening screw.

The dental implant is an elongated, generally cylindrical member which includes a first end and a second end, a first intermediate portion and a second intermediate portion. The first intermediate portion is slightly convex and is tapered. The first intermediate portion includes a self-tapping thread which is adapted for threading into a patient's jawbone. The dental implant has a bore which includes a tapered portion, a straight cylindrical portion, and a threaded portion.

The abutment is generally cylindrical and includes a first end and a second end. The outer surface of the abutment includes a cylindrical portion which leads to a first tapered portion which generally matches the taper of the dental implant and which leads to a cylindrical portion and a second tapered portion. The second tapered portion leads to a third tapered portion which leads to a wrench engaging surface which is disposed on the second end of the abutment. The abutment includes a bore within which a first cylindrical portion leads to a tapered portion which, in turn, leads to a second cylindrical portion.

The fastening screw has a threaded portion which engages the internally threaded portion of the abutment, a cylindrical portion and a head which includes a tapered portion. The tapered portion of the head matches the tapered portion in the bore of the abutment. The head also includes a wrench engaging surface.

The engaging tapered portions on the fastening screw and the abutment create a locking relationship between the fastening screw, the abutment and the dental implant.

### BRIEF DESCRIPTION OF THE DRAWINGS

Other important objects and advantages will be made clear with reference to the following description and drawings in which:

FIG. 1 is a cross-sectional view of a dental implant system made in accordance with the present invention;

FIG. 2 is a cross-sectional view of a fixation screw shown removed from the dental implant system of FIG. 1;

FIG. 3 is a cross-sectional view of an abutment shown removed from the dental implant system of FIG. 1;

FIG. 4 is a cross-sectional view of a dental implant shown removed from the dental implant system of FIG. 1;

FIG. 5 is a top plan view of the fixation screw of FIG. 2;

FIG. 6 is a top plan view of the fixation screw of FIG. 2 similar to FIG. 6 showing an alternative configuration of the wrench engaging surface; and

FIG. 7 is a cross-sectional view similar to FIG. 1 showing the use of an alternate abutment.

### DETAILED DESCRIPTION OF THE INVENTION

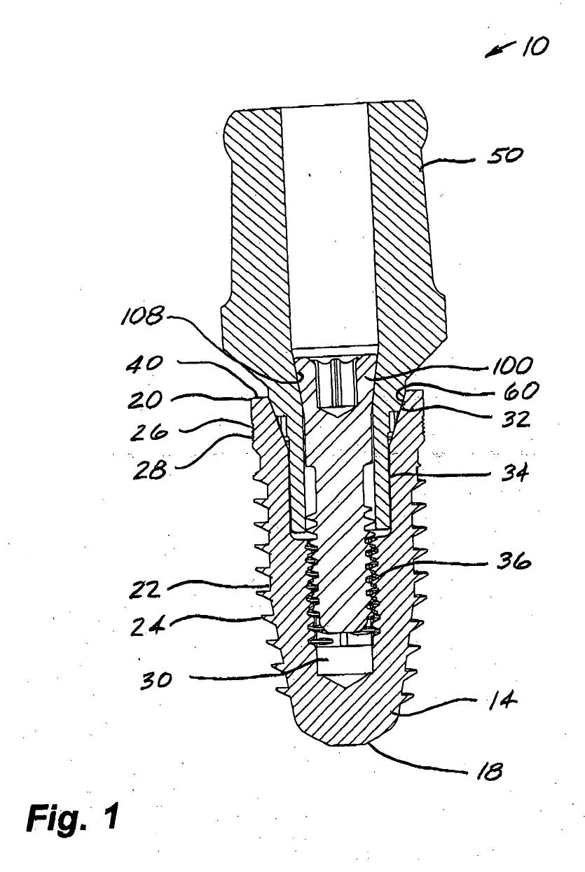

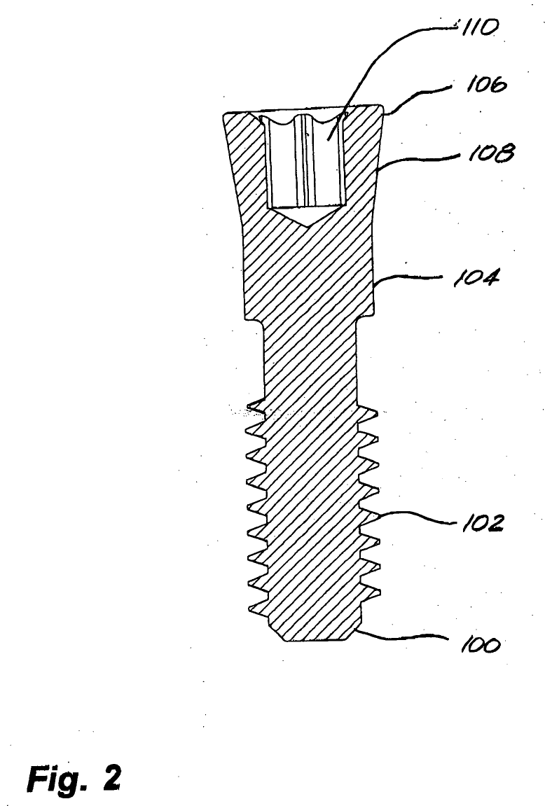

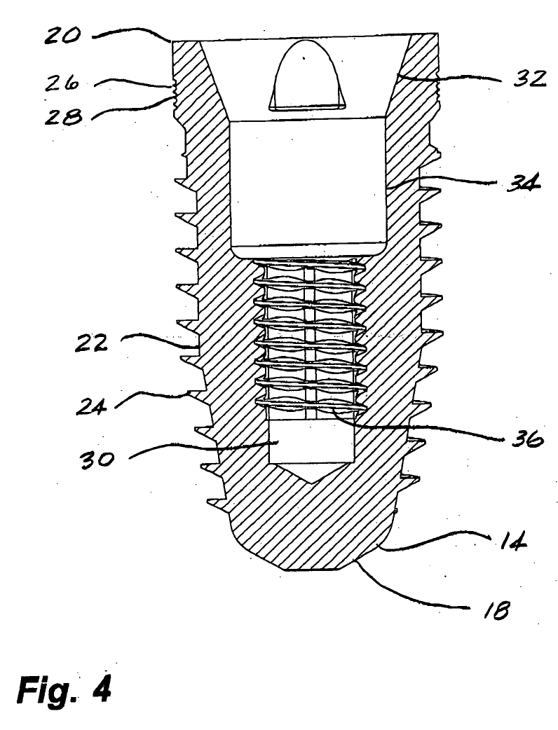

With reference to FIGS. 1-7, there is shown a dental implant system 10 which includes an abutment 50, a dental implant 14 and a fastening screw 100 made in accordance with the present invention.

The dental implant 14 is an elongated, generally cylindrical member which includes a first end 18, a second end 20, a first intermediate portion 22 and a second intermediate portion 26. The first intermediate portion 22 is slightly convex and is tapered. The first intermediate portion 22 includes a self-tapping thread 24 which is adapted for threading into a patient's jawbone. The second intermediate portion 26 includes a plurality of relatively fine grooves 28. The dental implant 14 has a bore 30 which includes a tapered portion 32, a straight cylindrical portion 34, and a threaded portion 36. The second end 20 includes a flat upper surface 40.

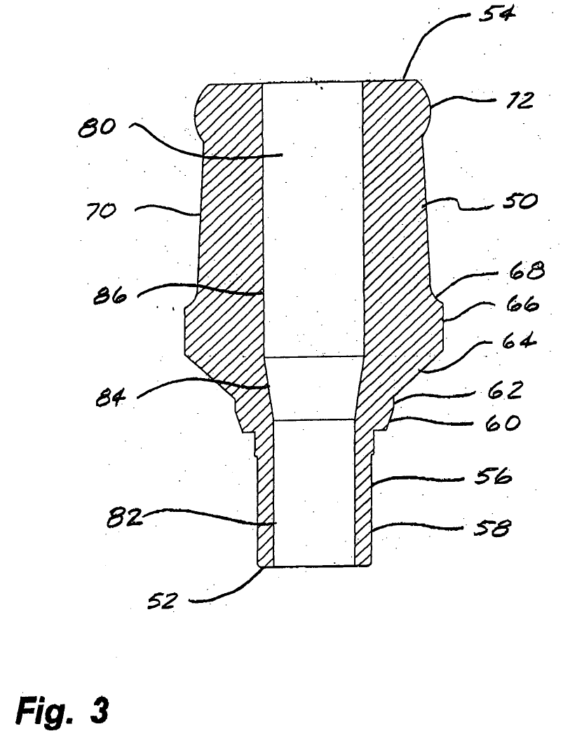

As is best shown in FIG. 3, the abutment 50 is generally cylindrical and includes a first end 52 and a second end 54. The outer surface 56 of the abutment 50 includes a first cylindrical portion 58 which leads to a first tapered portion 60 which matches the tapered portion 32 of the dental implant 14 and which leads in turn to a second cylindrical portion 62 and a second tapered portion 64. The second tapered portion 64 leads in turn to a third cylindrical portion 66, a curved portion 68 and a third tapered portion 70. A wrench engaging surface 72 is disposed on the second end 54 of the abutment 50. The abutment 50 includes a bore 80 which has a first cylindrical portion 82 which leads to a tapered portion 84 which, in turn, leads to a second cylindrical portion 86.

The fastening screw 100 has a threaded portion 102 which engages the internally threaded portion 36 of the dental implant 14, a cylindrical portion 104 and a head portion 106 which includes a tapered portion 108. The tapered portion 108 of the head 106 matches the tapered portion 84 in the bore 80 of the abutment 50 as will be presently described. The head portion 106 also includes a wrench engaging surface 110.

The tapered surface 84 on the abutment 50 and the tapered portion 108 on the head portion 106 form a key feature of the present invention 10.

The angle of taper of the tapered portion 108 on the head portion 106 of the fastening screw 100 is slightly greater than the angle of taper of the tapered surface 84 of the abutment 50.

The angle of taper of the tapered surface 108 on the fastening screw 100 and the tapered surface 84 on the abutment 50 is less than 15 degrees and is in the preferred range of 0.5 to 1.5 degrees. This preferred range of the angle of taper of the surfaces 84, 108 results in a secure locking relationship between the fastening screw 100 and the abutment 50 and the dental implant 14.

The wrench engaging surface 72 of the abutment 50 may preferably include a plurality of flat surfaces forming a hexagonal surface.

The wrench engaging surface may also include a plurality of concave surfaces, a plurality of convex surfaces, and a plurality of flat surfaces.

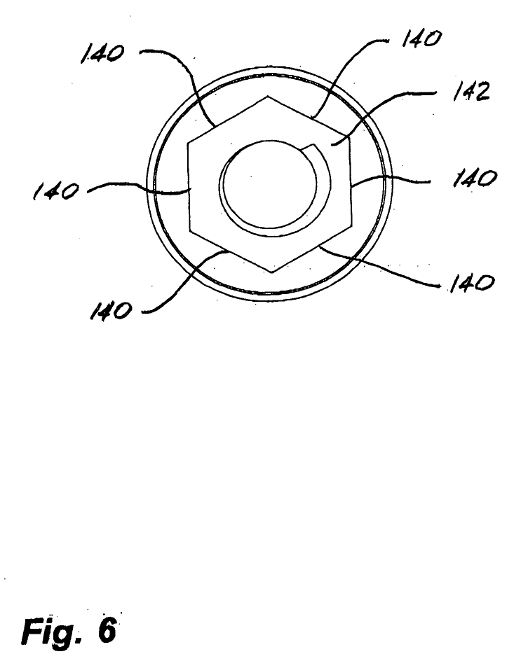

The wrench engaging surface 110 on the fastening screw 100 may include a plurality of flat surfaces 140 forming a hexagonal cavity 142 as is shown in FIG. 6.

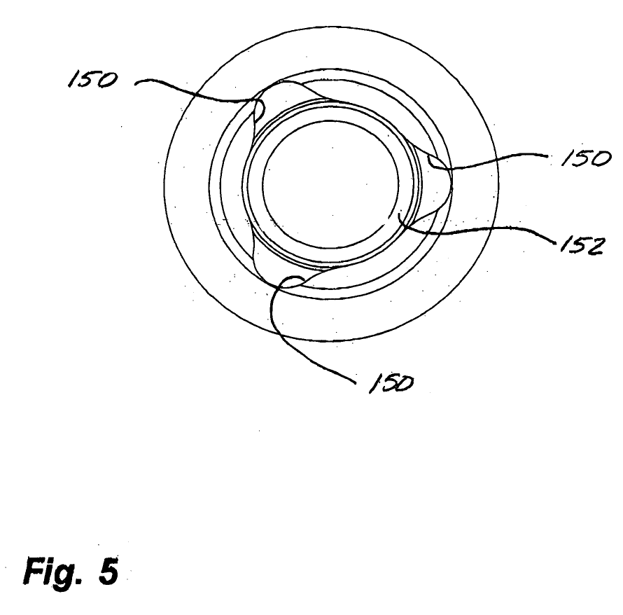

Alternatively, the wrench engaging surface 110 of the fastening screw 100 may include a plurality of curved surfaces 150 which form a multi-lobed cavity 152 as is shown in FIG. 5.

As is shown in FIG. 1, tightening the fastening screw 100 causes the tapered portion 60 of the abutment 50 to bear against the tapered portion 32 of the dental implant 14. The tapered portion 108 of the head 106 forms a locking relationship with the tapered surface 84 of the abutment 50 resulting in a secure and reliable connection between the fastening screw 100, the abutment 50 and the dental implant 14.

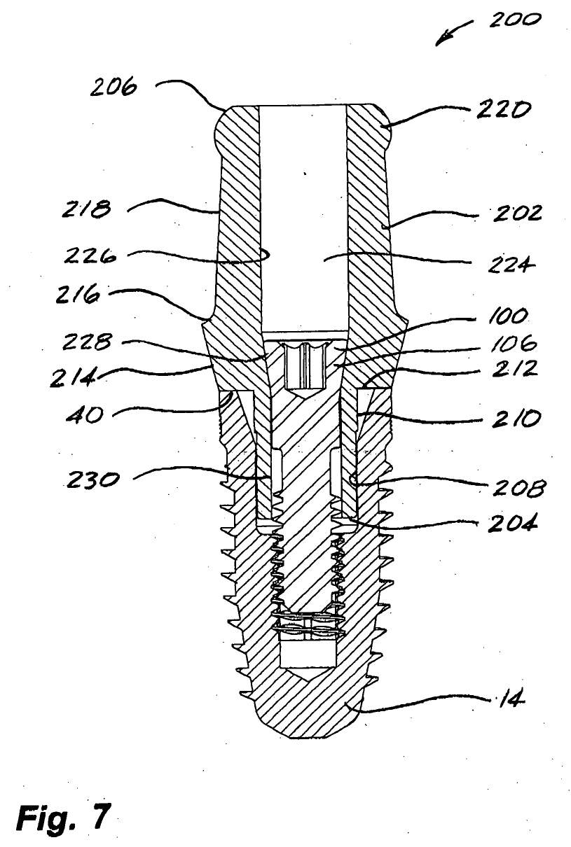

In an alternative embodiment of the invention 200 which is shown in FIG. 7 the dental implant 14 and the fastening screw 100 are the same as has been described in connection with FIG. 1. The abutment 202 shown in FIG. 7 is generally cylindrical and includes a first end 204 and a second end 206. The outer surface 208 of the abutment 202 includes a first cylindrical surface 208, a second cylindrical surface 210 which is slightly larger in diameter than the surface 208, and a step surface 212. The step surface 212 leads to an outwardly tapered surface 214 which leads to a curved surface 216. The curved surface 216 leads to a tapered surface 218. The tapered surface 218 leads to a wrench engaging surface 220 which is generally similar to the wrench engaging surface 72 which has been previously described.

The abutment 202 has a bore 224 and has a first cylindrical portion 226 which leads to a tapered portion 228 which in turn leads to a second cylindrical portion 230.

The angle of taper of the tapered portion 228 is the same as previously described in connection with the abutment 50.

Tightening the fastening screw 100 causes the step portion 212 of the abutment 202 to bear against the surface 40 of the dental implant 14 with the tapered portion 108 of the head 106 forming a locking relationship with the tapered portion 228. The dental implant 14, the fastening screw 100 and the abutment 202 form a secure and reliable connection.

The foregoing specific embodiment of the present invention as set forth in the specification herein is for illustrative purposes only. Various deviations and modifications may be made within the spirit and scope of the invention without departing from the main theme thereof.

What is claimed is:

1. A dental implant system comprising:
a dental implant with said dental implant having an internally threaded bore and a tapered portion;
an abutment with said abutment having a central bore with said central bore having a tapered portion, and
a fastening screw with said fastening screw having a threaded portion and a tapered head portion, with said tapered head portion having an angle of taper less than fifteen degrees and with said tapered head portion engaging said tapered portion of said abutment.

2. The dental implant system as claimed in claim 1, with said fastening screw further comprising a wrench engaging surface.

3. The dental implant system as claimed in claim 2 wherein said wrench engaging surface is generally concave.

4. The dental implant system as claimed in claim 2 wherein said wrench engaging surface comprises a plurality of convex portions, a plurality of concave portions, and a plurality of flat portions.

5. The dental implant system as claimed in claim 2 wherein said wrench engaging surface comprises a plurality of flat surfaces.

6. The dental implant system as claimed in claim 1 wherein said abutment has an angle of taper, wherein said tapered head portion of said fastening screw has an angle of taper and wherein said angle of taper of said tapered head portion is greater than said angle of taper of said abutment.

7. The dental implant system as claimed in claim 1 wherein said tapered portion of said fastening screw has an angle of taper of less than ten degrees.

8. The dental implant system as claimed in claim 1 further comprising an internal wrenching surface, with said internal wrenching surface disposed proximate to said tapered portion of said dental implant.

9. The dental implant system as claimed in claim 1 further comprising a projecting portion with said projecting portion disposed proximate to said tapered portion.

10. The dental implant system as claimed in claim 1 wherein said central bore in said abutment is generally concentric with said fastening screw.

11. The dental implant system as claimed in claim 6 wherein said angle of taper of said abutment is in the range of 0.5 to 1.5 degrees and wherein said angle of taper of said tapered head portion is in the range of 0.5 to 1.5 degrees.

12. The dental implant system as claimed in claim 1 wherein said tapered portion of said abutment and said tapered portion of said fastening screw are concentric.

13. The dental implant system as claimed in claim 1 further comprising an external wrenching surface, with said external wrenching surface disposed proximate to said tapered portion of said dental implant.

14. The dental implant system as claimed in claim 6 wherein said external wrenching surface comprises a plurality of flat surfaces.

15. The dental implant system as claimed in claim 6 wherein said external wrenching surface comprises a hexagonal surface.

16. The dental implant as claimed in claim 6 wherein said angle of taper of said abutment and said angle of taper of said tapered head portion are in the range of 0.5 to 15 degrees.
